(19) United States
(12) Patent Application Publication
(10) Pub. No.: US 2018/0315101 A1
(43) Pub. Date: Nov. 1, 2018

(54) SYSTEM AND METHOD FOR OPTIMIZING REVENUE GENERATION PROCESS

(71) Applicant: Yogesh Ramdas KADAM, Navi Mumbai (IN)

(72) Inventor: Yogesh Ramdas KADAM, Navi Mumbai (IN)

(21) Appl. No.: 15/821,771

(22) Filed: Nov. 23, 2017

(30) Foreign Application Priority Data
Apr. 29, 2017 (IN) 201721015258

(51) Int. Cl. G06Q 30/04; G06Q 10/10

(52) U.S. Cl. CPC G06Q 30/04; G06Q 10/10

(57) ABSTRACT

The present invention discloses a system for optimizing the revenue generation, comprising at least one storage component, two service components, management and maintenance service component and the project based service component; and a consolidated pricing schedule module develop in the form of a package. The method for optimizing the revenue generation process, comprising the steps of combining data of the storage, service based component, pricing module; generating a package from the combination in the system and charged with an amount for a month; initiating a bill at the end or beginning of at least one month in the system; printing the bill generated and dispatching bill to a customer for making the payment; and receiving payment in a maximum of 30 days from date of bill generated.

### FIELD OF THE INVENTION

The present invention relates to the field of inventory management systems for the records and documents management industries, more specifically the present invention relates to an improved system and a method using a unified billing procedure, particularly based on the storage, management/maintenance and project based services, thereby resulting in optimized higher revenue generation.

### BACKGROUND OF THE INVENTION

There are many organizations that require management and maintenance of their physical records related to their products or services or other resources. Depending on the organization needs, one may need to maintain printed or signed documents in their physical form that could prove to be technically cumbersome and expensive. More the organization grows, more storage for the physical records is needed where more storage of such vital resources calls for security risks with the data stored. It also becomes costly to own a storage and keep its maintenance.

In order to overcome such issues and risks, the record management or document management industry comes as a boon to the organizations. These record management service providers provide a complete storage space to their clients for the vital physical resources like paper files and other such inventories. They provide services for proper management and maintenance of these resources to the client like storage, retrieval and transportation of resources from one location to another.

Presently, the record management service providers employ the system or process in which each service is provided as a separate or individual service and thus charged separately referring to individual rate sheet/pricing schedule/tariffs/commercial charges/cost sheet for each service. The billing at the beginning of each month is done related to previous month's services delivered and/or following or coming month's storage charges in advance and/or project based services.

Further, the billing system is based on all the assured services followed with terms and conditions as per the agreement viz.: Storage, Services and Projects.

Storage refers to storage of files or records or documents in the cartons or boxes on monthly basis and these cartons/boxes are made from paper, plastic or wood based material and are thus chargeable accordingly.

Services refers to the most commonly used/primary services viz.: Adding new cartons/boxes (empty carton, material, packing, inventory, metadata, indexing, cataloguing, barcoding, initial charges, transportation, labour, scanning, binding, etc.); Retrieval (retrieval, normal delivery, express delivery, same day delivery, urgent delivery, scan delivery, photocopy, in-house access, audits, percent out, destruction, re boxing, etc.); Refilling cartons/boxes (transportation, labour, refilling, permanent out and destruction/'s of records/cartons/boxes); and Actual cost (transportation, labour, etc.).

Projects refers to project that have set process and timelines but are not related to Storage and may include data entry, data correction, data capturing, scanning, digitization, one time shifting of cartons from one location to another location, software solutions also referred to as DMS (Document Management System or Data Management System or Database Management System), movement of records from one office to another office or one location to another, also referred to as one time project related service.

For each customer, bill is calculated at different levels viz., Storage bill as per the total number of cartons or boxes stored and bill for different services delivered to the customers. In other words, the billing process has multilevel parameters like adding new cartons or boxes, retrieval, refilling cartons or boxes, permanent out and destruction of records or cartons or boxes. These hard copy/printed bills are then hand delivered to the customer followed with payment from customers. The payment towards the bills may result in delay because of errors related to Storage and Services followed with soft or hard copy evidences. This delay may cause the payment to fall in outstanding bucket or aging bucket viz.: 30 to 60 days, 61 to 90 days, 91 to 120 days, 121 days and more/plus days.

Bills calculated at multiple levels undergoes; Multiple level checks by the department; Multiple level corrections in case of discrepancies; a Multiple level approvals by the authorities.

FIG. 1 illustrates the prior process of billing as explained in following steps:

Step 1. Data related to Storage provided and Services delivered, generated by the system or manually, are collated in the system.

Step 2. Bill is generated on the basis of the data received at the end of the month or the beginning of the month.

Step 3. These bills are validated with system (software based, excel based or hardcopy document of evidence) for storage and service count.

Step 4. If the billed amount matches with storage and service they are sent for further approval. Else if the billed amount does not match with the storage and services delivered, they are sent for investigation to find the gaps thereby delaying the process of bill generation and bill submission.

Step 5. Once the bill generated is approved, printed bill is generated and dispatched to the client for payment on time i.e. within 30 days of the bill generated date.

Step 6. In case of mismatch at step 3 in the process, delay in investigation, correction and approval leads to delay in payment. This delayed payment falls in the outstanding bucket or aging bucket of 30 to 60 days, 61 to 90 days, 91 to 120 days, 121 days and more or plus days depending on the delay time.

However, almost every organization needs all the services as a whole. In such case, charging separate fees for each service, generating bills depending on each service, validating and correcting them and then generating the final invoice for a client takes a lot of time causing delay in billing and payments. This delay may further lead to revenue leakages, billing errors, frauds, delayed payments, delinquent accounts and carton count mismatch. This may also lead to misunderstanding of terms and conditions/service charges in agreements firstly, by incorrect billing system leading to revenue leakages, secondly generation of less value bills leading to fraud.

In view of the drawbacks associated with the existing system and process, there is a need to develop an improved system and method using a unified billing procedure, particularly based on the storage, management/maintenance and project based services, thereby resulting in higher revenue generation.

The present invention addresses the shortcomings of the aforesaid prior systems and processes, and provides an improved system and method that uses a smart and improved billing procedure to generate a consolidated or all-inclusive invoice or bill for the data related to storage and services delivered.

### OBJECTS OF THE INVENTION

The primary object of the present invention is to overcome the disadvantages of the previous systems and processes and to provide an improved system and method that uses a smart and improved billing procedure to generate a consolidated or all-inclusive invoice or bill for the data related to storage and services delivered.

Another object of the present invention is to provide easy and simplified method of higher revenue generation for the record management or document management service providers.

Yet another object of the present invention is to provide an improved system and method that offers and simplifies the revenue generation techniques by using consolidated rate sheet/pricing schedule/tariff details/commercial charges/cost sheet and the use of consolidated rate sheet/pricing schedule/tariff details/commercial charges/cost sheet will result in smart and easy billing procedure by generating all-inclusive bill or single line item bill.

Another object of the present invention is to reduce the multiple level process including checks, corrections and approvals to single level process for generating final invoice to the customers/clients.

Yet another object of the present invention is to motivate organizations for keeping and maintaining their vital physical records or files or documents at safer place without the worry of managing the storage space required and with reduced expenses for the purpose.

Yet another object of the present invention is to provide a consolidated bill or invoice based on the services rendered, wherein said bill generated reduces the billing errors, revenue leakages, delayed payments and carton count mismatch.

Yet another object of the present invention is to provide a consolidated bill which does not require any validation and approval at multiple levels within the company, thereby saving effort and time.

These and other objects and advantages of the present invention will become apparent from the following detailed description taken in conjunction with the accompanying drawings.

### SUMMARY OF THE INVENTION

The following presents a simplified summary of the subject matter in order to provide a basic understanding of some aspects of the embodiments of the present invention. This summary is not an extensive overview of the subject matter. It is not intended to identify key/critical elements of the embodiments or to delineate the scope of the subject matter.

The present invention is directed to an improved inventory system and method that uses an integrated billing procedure or process, particularly based on the storage, management/maintenance and project based services, thereby resulting in higher revenue generation.

According to first embodiment of the present invention, the system for optimizing the revenue generation, comprising at least one storage component, wherein said component keeps a storage space for a plurality of files or records or documents in a plurality of cartons or boxes; at least two service components, wherein the first service component is the management and maintenance service component and second is the project based service component; and a consolidated pricing schedule module, wherein said schedule is developed based on said services in the form of a package and further rendered for a predefined amount of time to a customer.

According to another embodiment of the present invention, the management and maintenance service component comprises of primary services like adding new cartoons/boxes, retrieving and refilling of carton/boxes.

According to another embodiment of the present invention, the project based service component, comprises of data entry, data correction, data capturing, scanning, digitization and software solutions.

According to second embodiment of the present invention, the method for optimizing the revenue generation process, comprising the steps of combining the storage, service based component and the pricing module data; generating a package from the combination of said storage, service based component and pricing module data in the system, wherein the said package is charged with a predefined amount for at least one month; initiating a bill generation process at the end or beginning of at least one month in the system; printing said bill generated and further dispatching said bill to a customer for making the payment; and receiving said payment by the company in a maximum of 30 days from date of said bill generated.

### BRIEF DESCRIPTION OF DRAWINGS

The present invention may be better understood and its numerous objects, features, components and advantages are made apparent to those skilled in the art, by referring to the accompanying drawing, in which:

FIG. 1 illustrates a flow diagram of the conventional process of record or document management system; and

FIG. 2 illustrates a flow diagram of the proposed process according to any exemplary embodiment of the present invention.

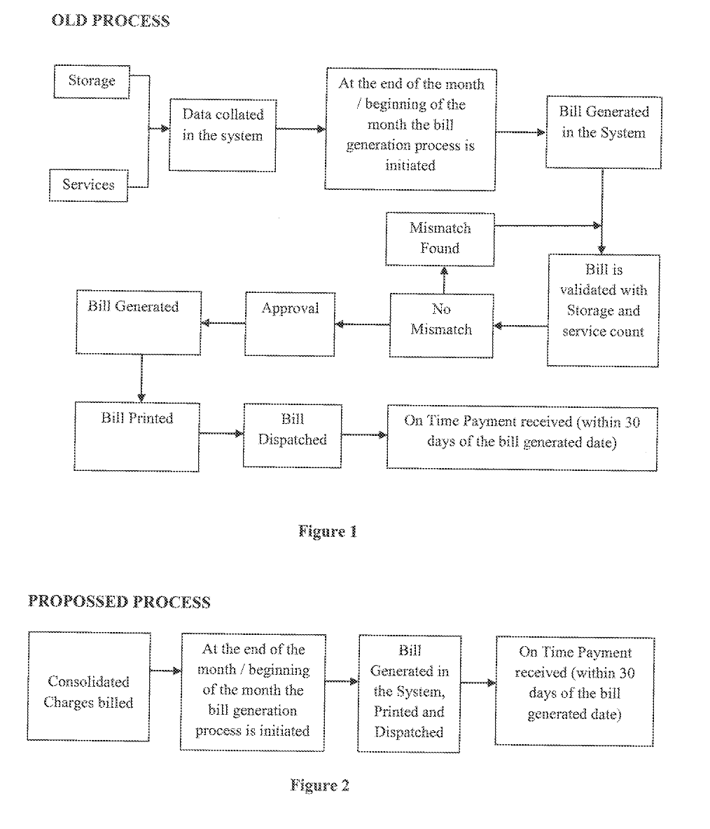

### DETAILED DESCRIPTION OF THE INVENTION

The following description describes various features and functions of the disclosed system and method with reference to the accompanying figures. The terminology used herein is for the purpose of describing particular embodiments only and is not intended to limit the scope of the present invention.

The detailed description is construed as a description of the currently preferred embodiment of the present invention and does not represent the only form in which the present invention may be practiced. This is to be understood that the same or equivalent functions may be accomplished, in any order unless expressly and necessarily limited to a particular order, by different embodiments that are intended to be encompassed within the scope of the present invention.

The embodiment is chosen and described to provide the best illustration of the principles of the invention and its practical application, and to enable one of ordinary skill in the art to utilize the invention in various embodiments and with various modifications as are suited to the particular use contemplated.

Furthermore, there is no intention to be bound by any expressed or implied theory presented in the preceding technical field, background, brief summary or the following detailed description. It is further understood that the relational terms such as first, second etc., if any, are used solely to distinguish one from another entity, item or action without necessarily requiring or implying any actual such relationship or order between such entities, items or actions.

The present invention is directed to an improved inventory system and method that uses an integrated billing procedure or process, particularly based on the storage, management/maintenance and project based services, thereby resulting in higher revenue generation.

The system for optimizing the revenue generation, comprising at least one storage component, wherein the component keeps a storage space for a files or records or documents in cartons or boxes; at least two service components, wherein the first service component is the management and maintenance service component and second is the project based service component; and a consolidated pricing schedule module developed based on services in the form of a package and further rendered for a predefined amount of time to a customer.

Also, the management and maintenance service component comprises of primary services like adding new cartoons/boxes, retrieving and refilling of carton/boxes. Further, the project based service component, comprises of data entry, data correction, data capturing, scanning, digitization and software solutions.

FIG. 2 illustrates the method for optimizing the revenue generation process, comprising the steps of combining the storage, service based component and the pricing module data; generating a package from the combination of the storage, service based component and pricing module data in the system, wherein package is charged with a predefined amount for at least one month; initiating a bill generation process at the end or beginning of at least one month in the system; printing said bill generated and further dispatching said bill to a customer for making the payment; and receiving payment by the company in a maximum of 30 days from date of bill generated.

Consolidated rate sheet/pricing schedule/tariffs/commercial charges/cost sheet for the storage and services, to be provided to the customer, is designed in the form of a package according to the primary agreement signed between the company and the customer. This package is charged with a fixed amount for a month for all the services and storage to be allowed to a customer as per the primary agreement.

At the end of the month/beginning of the month the bill generation process is initiated considering the package amount as well as any other additional amount is applicable, like additional service apart from the package, tax etc.

Since the bill generated for storage and services is based on the consolidated rate sheet/pricing schedule/tariffs/commercial charges/cost sheet, it does not require further validation and approval by each thus saving the time.

Final invoice or bill is then printed and dispatched to the client for payment on time i.e. within 30 days of the bill generated date.

Since the bill is generated in time, the payment is also received in time i.e. within 30 days, thus reducing the chances of payments falling in the outstanding bucket or aging bucket of 30 to 60 days, 61 to 90 days, 91 to 120 days, 121 days and more or plus days.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments.

It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

Although the embodiments herein are described with various specific embodiments, it will be obvious for a person skilled in the art to practice the invention with modifications. However, all such modifications are deemed to be within the scope of the claims.

It is also to be understood that the following claims are intended to cover all the generic and specific features of the embodiments described herein and all the statements of the scope of the embodiments which as a matter of language might be said to fall there between.

I claim:

1) A system for optimizing the revenue generation, comprising:
at least one storage component;
at least two service components; and
a consolidated pricing schedule module;
wherein:
said storage component has a storage space for a plurality of files or records or documents in a plurality of cartons or boxes;
the first service component is the management and maintenance service component and second is the project based service component; and
said consolidated pricing schedule module is developed based on said services in the form of a package and further rendered to a customer for a predefined amount of time, thereby simplifying the bill generation process.

2) A system for optimizing the revenue generation as claimed in claim 1, wherein said management and maintenance service component, comprises of primary services like adding new cartoons/boxes, retrieving and refilling of carton/boxes.

3) A system for optimizing the revenue generation as claimed in claim 1, wherein said project based service component, comprises of data entry, data correction, data capturing, scanning, digitization and software solutions.

4) A system for optimizing the revenue generation as claimed in claim 1, wherein said cartons/boxes are preferably made from paper, plastic or wood based material.

5) The method for optimizing the revenue generation process in the system as claimed in claim 1, comprising the steps of:
combining the data of the storage, service based component and the pricing module;
generating a package from the combination of said storage, service based component and pricing module data in the system, wherein said package is charged with a predefined amount for at least one month;
initiating a bill generation process at the end or beginning of at least one month in the system;
printing said bill generated and further dispatching said bill to a customer for making the payment; and
receiving said payment by the company in a maximum of 30 days from date of said bill generated.

6) The method for optimizing the revenue generation process as claimed in claim 5, wherein said payment received within 30 days reduces the chances of payments falling in the outstanding bucket of 30 to 60 days, 61 to 90 days, 91 to 120 days, 121 days and more.

7) The method for optimizing the revenue generation process as claimed in claim 5, wherein said bill or invoice to customer is generated on the basis of consolidated rate sheet/pricing schedule/tariffs/commercial charges/cost sheet designed as per the primary agreement signed between the company and the customer.

8) The method for optimizing the revenue generation process as claimed in claim 5, wherein said bill is inclusive of all services and hence does not require validation and approval at multiple levels within the company, saving efforts and time.
